(19) United States
(12) Patent Application Publication
(10) Pub. No.: US 2023/0377476 A1
(43) Pub. Date: Nov. 23, 2023

(54) PROVIDING PERSONALIZED READING ASSISTANCE USING VISUAL MODIFICATIONS

(71) Applicant: INTERNATIONAL BUSINESS MACHINES CORPORATION, Armonk, NY (US)

(72) Inventors: Krishnakanth M. Naik, Bangalore (IN); Manjit Singh Sodhi, Bangalore (IN); Sri Harsha Varada, Vizianagaram (IN); PRERNA AGARWAL, New Delhi (IN)

(21) Appl. No.: 17/664,116

(22) Filed: May 19, 2022

(51) Int. Cl. G09B 17/00; G06F 40/242; G09B 5/02

(52) U.S. Cl. CPC G09B 17/003; G06F 40/242; G09B 5/02

(57) ABSTRACT

A method for providing personalized reading assistance using visual modifications. The method includes forecasting a complexity of a text corpus for a user. The text corpus includes a plurality of words. Visual modifications may be provided to at least some words of the plurality of words in the text corpus based on the forecast complexity of the text corpus for the user.

### BACKGROUND

Exemplary embodiments of the present inventive concept relate to providing reading assistance, and more particularly, to providing personalized reading assistance using visual modifications.

Reading is one of the most fundamental modern skills. In addition to being a source of entertainment, reading is invaluable to mastering new skills and knowledge necessary for advancement occupationally, academically, interpersonally, in competitive hobbies, in do-it-yourself projects, etc. Regardless of an individual's motivation for reading, learning new information from a text corpus can present varying degrees of difficulty. Variables which influence the degree of difficulty of the text corpus to a reader include their learning disabilities, eye anatomy, education level, familiarity with a particular subject, preferred learning style, and a general complexity of the text. Reading can be mentally and physically taxing, especially when these variables of difficulty degree are not shown due importance. Mental fatigue and eyeball strain associated with improper reading technique and repetitive reading behaviours can ensue; affected readers will both read and retain less in a single sitting and take longer to read a given text corpus.

### SUMMARY

Exemplary embodiments of the present inventive concept relate to a method, a computer program product, and a system for providing personalized reading assistance using visual modifications.

According to an exemplary embodiment of the present inventive concept, a method may be provided for personalized reading assistance using visual modifications. The method may include forecasting a complexity of a text corpus for a user. The text corpus may include a plurality of words. Visual modifications may be provided to at least some words of the plurality of words in the text corpus based on the forecast complexity of the text corpus for the user.

According to an exemplary embodiment of the present inventive concept, a computer program product may be provided for providing personalized reading assistance using visual modifications. The computer program product may include one or more non-transitory computer-readable storage media and program instructions stored on the one or more non-transitory computer-readable storage media capable of performing a method. The method may include forecasting a complexity of a text corpus for a user. The text corpus may include a plurality of words. Visual modifications may be provided to at least some words of the plurality of words in the text corpus based on the forecast complexity of the text corpus for the user.

According to an exemplary embodiment of the present inventive concept, a computer system may be used to provide personalized reading assistance using visual modifications. The system may include one or more computer processors, one or more computer-readable storage media, and program instructions stored on the one or more of the computer-readable storage media for execution by at least one of the one or more processors capable of performing a method. The method includes forecasting a complexity of a text corpus for a user. The text corpus includes a plurality of words. Visual modifications may be provided to at least some words of the plurality of words in the text corpus based on the forecast complexity of the text corpus for the user.

### BRIEF DESCRIPTION OF THE DRAWINGS

The following detailed description, given by way of example and not intended to limit the exemplary embodiments solely thereto, will best be appreciated in conjunction with the accompanying drawings, in which:

FIG. 1 illustrates a schematic diagram of a personalized reading assistance system 100, in accordance with an exemplary embodiment of the present inventive concept.

FIG. 2 illustrates a flowchart of personalized reading assistance 200 provided by a personalized reading assistance program 134 of the personalized reading assistance system 100, in accordance with an exemplary embodiment of the present inventive concept.

FIG. 3 illustrates a block diagram depicting the hardware components included in the personalized reading assistance system 100 of FIG. 1, in accordance with an exemplary embodiment of the present inventive concept.

FIG. 4 illustrates a cloud computing environment, in accordance with an exemplary embodiment of the present inventive concept.

FIG. 5 illustrates abstraction model layers, in accordance with an exemplary embodiment of the present inventive concept.

It is to be understood that the included drawings are not necessarily drawn to scale/proportion. The included drawings are merely schematic examples to assist in understanding of the present inventive concept and are not intended to portray fixed parameters. In the drawings, like numbering may represent like elements.

### DETAILED DESCRIPTION OF THE DRAWINGS

Exemplary embodiments of the present inventive concept are disclosed hereafter. However, it shall be understood that the scope of the present inventive concept is not limited thereto. The disclosed exemplary embodiments are merely illustrative of the claimed system, method, and computer program product. The present inventive concept may be embodied in many different forms and should not be construed as limited to only the exemplary embodiments set forth herein. Rather, these included exemplary embodiments are provided for completeness of disclosure and to facilitate an understanding to those skilled in the art. In the detailed description, discussion of well-known features and techniques may be omitted to avoid unnecessarily obscuring the presented exemplary embodiments.

References in the specification to “one embodiment,” “an embodiment,” “an exemplary embodiment,” etc., indicate that the embodiment described may include a particular feature, structure, or characteristic, but not every embodiment may necessarily include that feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments of the present inventive concept, in the following detailed description, some processing steps or operations that are known in the art may have been combined for presentation and for illustration purposes, and in some instances, may have not been described in detail. Additionally, some processing steps or operations that are known in the art may not be described at all. The following detailed description is focused on the distinctive features or elements of the present inventive concept according to various exemplary embodiments.

As previously mentioned, the perceived degree of difficulty of a text, and consequently reading proficiency. may be influenced by a variety of difficulty factors including, but not limited to: learning disabilities, eye anatomy, education level, familiarity with a particular subject, general complexity of text, and a user's preferred learning style.

Conventional approaches to improving reading proficiency have relied on the use of physical therapy-based trainings and rudimentary reading pacers. Rudimentary reading pacers include manually manipulated physical tools that obscure surrounding text as a user reads, and digital reading pacers which highlight text and are adjustable only with respect to a uniform highlight speed and colour. Neither variety of reading pacer addresses a reader's unique needs. There have also been studies and research performed in the field of Neuro Linguistic Science to improve individual reading speed. However, reading assistance trainings are typically physical therapy based, generic, and neglect the unique attributes and background of the reader. Moreover, these reading assistance trainings are tedious, require trained human guidance, repetitious testing, and do not necessarily facilitate increased reading comprehension, but instead prioritize ocular muscle efficiency. Thus, the physical therapy-based reading trainings employed for increasing reading proficiency are often unsuccessful for readers (also referred to herein as users) and/or require impractical maintenance and continual adjustment by a trained person.

Unfortunately, existent reading pacers are rudimentary and do not account for the individual needs of readers. The present inventive concept provided herein provides for personalized reading assistance using visual modifications that can be tailored to the unique needs of each reader and thus improve their reading speed/comprehension while avoiding frustration, excessive eye strain, and mental fatigue. The present inventive concept may provide these visual modifications to text (digital or physical) to facilitate reading ease, disability mitigation, and progressive proficiency improvements.

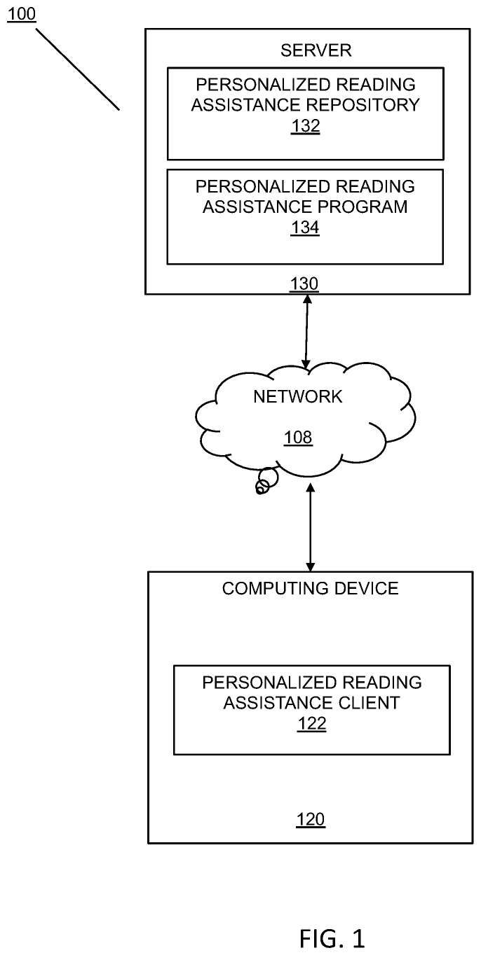

FIG. 1 depicts a schematic diagram of a personalized reading assistance system 100, in accordance with an exemplary embodiment of the present inventive concept.

The personalized reading assistance system 100 may include a user-operated computing device 120 and a personalized reading assistance server 130, which may all be interconnected via a network 108. Programming and data content may be stored and accessed remotely across several servers via the network 108. Alternatively, programming and data may be stored locally on as few as one physical computing device 120 or stored amongst multiple computing devices.

According to the exemplary embodiment of the present inventive concept depicted in FIG. 1, the network 108 may be a communication channel capable of transferring data between connected devices. The network 108 may be the Internet, representing a worldwide collection of networks 108 and gateways to support communications between devices connected to the Internet. Moreover, the network 108 may utilize various types of connections such as wired, wireless, fiber optic, etc., which may be implemented as an intranet network, a local area network (LAN), a wide area network (WAN), or a combination thereof. The network 108 may be a Bluetooth network, a Wi-Fi network, or a combination thereof. The network 108 may operate in frequencies including 2.4 GHz and 5 GHz internet, near-field communication, Z-Wave, Zigbee, etc. The network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices.

The computing device 120 may include the a personalized reading assistance client 122, and may be an enterprise server, a laptop computer, a notebook, a tablet computer, a netbook computer, a personal computer (PC), a desktop computer, a server, a personal digital assistant (PDA), a smart phone, a mobile phone, a virtual device, a thin client, an IoT device, or any other electronic device or computing system capable of sending and receiving data to and from other computing devices. Although the computing device 120 is shown as a single device, the computing device 120 may be comprised of a cluster or plurality of computing devices, in a modular manner, etc., working together or working independently.

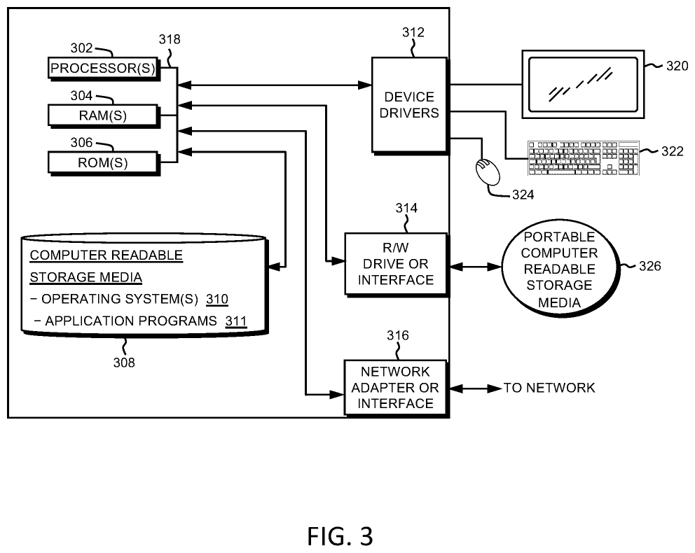

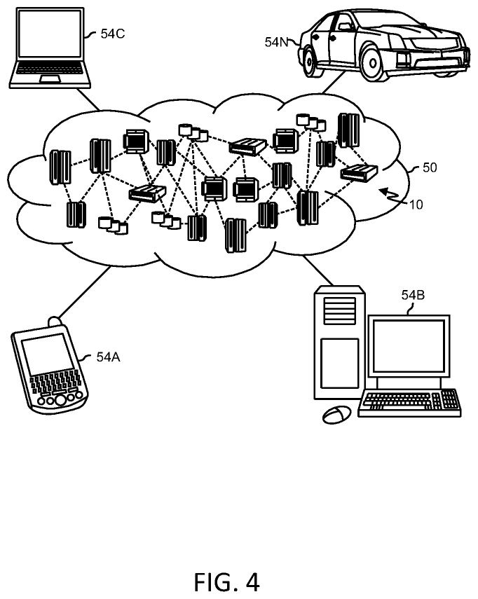

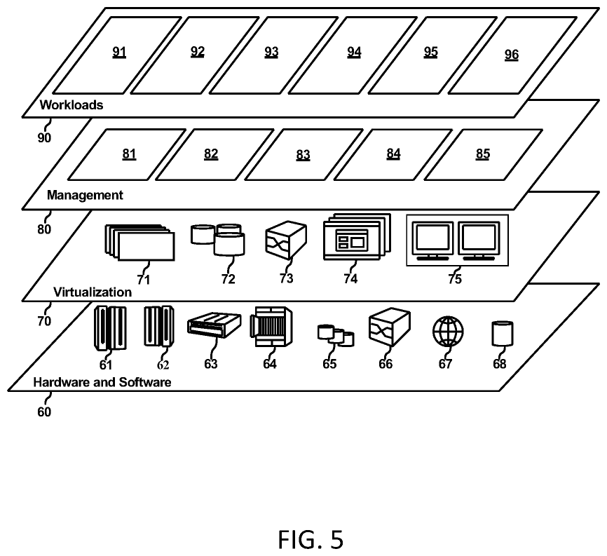

The computing device 120 is described in greater detail as a hardware implementation with reference to FIG. 3, as part of a cloud implementation with reference to FIG. 4, and/or as utilizing functional abstraction layers for processing with reference to FIG. 5.

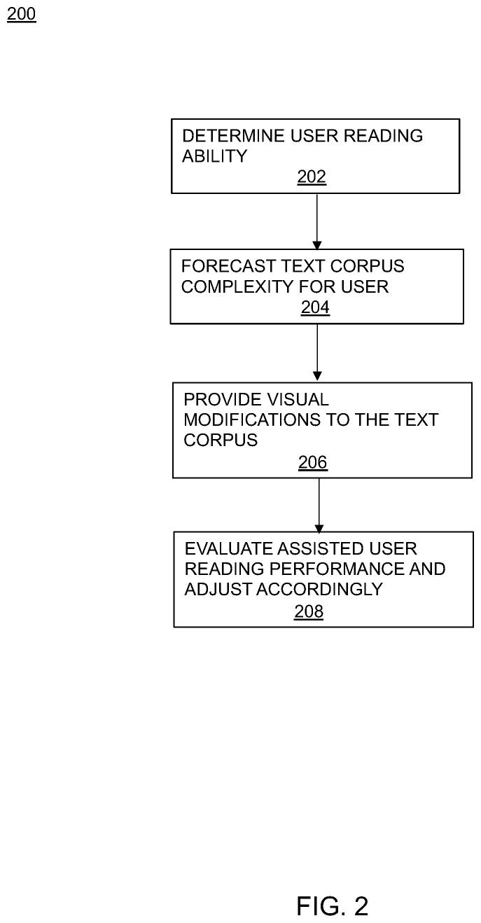

The personalized reading assistance client 122 may act as a client in a client-server relationship with a server, for example the personalized reading assistance server 130. The personalized reading assistance client 122 may be a software and/or a hardware application capable of communicating with and providing a user interface for a user to interact with the personalized reading assistance server 130 and/or other computing devices via the network 108. Moreover, the personalized reading assistance client 122 may be capable of transferring data between the computing device 120 and other computer devices/servers via the network 108. The personalized reading assistance client 122 may utilize various wired and wireless connection protocols for data transmission and exchange, including Bluetooth, 2.4 GHz and 5 GHz internet, near-field communication, etc. The personalized reading assistance client 122 is described in greater detail with respect to FIGS. 2-5.

The personalized reading assistance server 130 may include a personalized reading assistance repository 132 for storing various data (described hereinafter) and the personalized reading assistance program 134 (also described hereinafter). The personalized reading assistance server 130 may act as a server in a client-server relationship with a client, e.g., the personalized reading assistance client 122. The personalized reading assistance server 130 may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending and receiving data to and from other computing devices. Although the personalized reading assistance server 130 is shown as a single computing device, the present inventive concept is not limited thereto. For example, the personalized reading assistance server 130 may be comprised of a cluster or plurality of computing devices, in a modular manner, etc., working together or working independently.

The personalized reading assistance server 130 is described in greater detail as a hardware implementation with reference to FIG. 3, as part of a cloud implementation with reference to FIG. 4, and/or as utilizing functional abstraction layers for processing with reference to FIG. 5. The personalized reading assistance program 134 and/or the personalized reading assistance client 122 may be software and/or hardware programs that may facilitate personalized reading assistance discussed in further detail with reference to FIGS. 2-5.

FIG. 2 illustrates the flowchart of personalized reading assistance 200, in accordance with an exemplary embodiment of the present inventive concept.

The personalized reading assistance program 134 may determine a reading ability of the user (step 202). The reading ability of the user may be based on machine learning analysis of the user's reading performance evaluation results (e.g., reading pace in words-per-minute (WPM), detected learning disabilities and/or atypical eye movement, reading comprehension, ability to skim, recall, etc.), user reactions to a reading performance evaluation(s) (e.g., purposeful reactions, reflexive reactions, feedback, etc.), and/or user provided background inputs (e.g., recent sleep deficit, transient illness, learning disabilities, eye anatomy, education level, familiarity with a particular subject, preferred learning style, a general complexity of text, etc.). The reading ability of the user may be scored. The scored reading ability of the user may be based on a comparison with the reading ability of the user's peers (e.g., an average reading ability of the general population or individuals with at least one similar background input). The results of reading performance evaluations may be obtained and analyzed by the personalized reading assistance program 134 via natural language processing (NLP) and/or optical character recognition (OCR) of relevant user provided materials (digital and/or hard copy) and/or retrieved from the personalized reading assistance repository 132.

In an embodiment, the personalized reading assistance program 134 may perform a new reading performance evaluation (e.g., initial/baseline) of the user. The new reading performance evaluation may be performed by the personalized reading assistance program 134 by tracking and analyzing the user's eye movement/position via a camera (e.g., a webcam, infrared eye tracker, smart glasses, etc.). The user's eye movement/position may be mapped to corresponding text positions (e.g., words, paragraphs, sections, pages, etc.) on a text corpus based on angulation/movement of the user's eye (e.g., the iris) and/or display screen features of the computing device 120 which influence the corresponding text (e.g., screen tilt, text size, etc.). The user's eye movement/position may be compared with the position of a reading pacer. The reading pacer may be a default, pre-personalized pacer or a preliminarily personalized pacer based on available information on the user's reading ability. The WPM of the user may be calculated based on the number of words read by the user in a given time frame as determined by the user's eye movement/position and/or the reading pacer position (e.g., time spent to change a page having X words, scroll distance over X words, etc.). The personalized reading assistance program 134 may evaluate the user during a planned new reading performance examination or organically as the user reads (with advance user consent) but the user is not necessarily aware that a new performance evaluation is being performed (e.g., during a permitted time span or when an authorized subject is detected by NLP). The personalized reading assistance program 134 may evaluate the user's new reading performance evaluation in relation to at least a portion of a selected text corpus (e.g., random, target subject, length, complexity, source, section, specific user preselection, etc.). The text corpus may be obtained by the personalized reading assistance program 134 from the user (e.g., scanned, downloaded, etc.), over the network 108, and/or retrieved from the personalized reading assistance repository 132 (e.g., using a keyword search and/or NLP). In an embodiment, at least a portion of various text corpora may be compiled by the personalized reading assistance program 134 for use in a same new reading performance evaluation at different time intervals (e.g., interspersed, random, varied by complexity/subject, pertinent to a particular topic/field, etc.). Tested reading style (e.g., skimming, scanning, etc.) may also be varied during the new reading performance evaluation. The personalized reading assistance program may switch between skimming, scanning, and close reading pacer modes and/or directives given to the user, etc.

In an embodiment, a reading comprehension and/or recall assessment may also be performed and/or evaluated as part of the user's overall reading ability assessment. The reading comprehension and/or recall assessment may be generated by the personalized reading assistance program 134 (e.g., fill in the blanks, multiple choice sentence recall, semantic analysis derived questions, prior expert determined questions, etc.).

During the new reading performance evaluation, user reactions (e.g., reflexive reactions, purposeful reactions, and feedback) suggestive of effort level (e.g., ease, enjoyment, struggle, confusion, surprise, frustration, etc.) may be recorded by the personalized reading assistance program 134. Reflexive reactions of the user may include unconscious body language and/or communications (e.g., smiling, nodding, laughing, blinking, sighing, grunting, twitching, rubbing eyes/hands, squinting, changing head angle/distance from a screen of the computing device 120, unilateral and/or bilateral eye movement, forehead creasing, frowning, eyebrows raising/furrowing, eyelid drooping, lip biting, etc.). The purposeful user reactions may include intra-evaluation deliberate communications with the personalized reading assistance program 134 (e.g., clicking, typing, rewinding/slowing/fast-forwarding/pausing the reading pacer, highlighting words, speaking, motioning, gesturing, and/or otherwise intentionally conveying to the personalized reading assistance program 134 in a predetermined manner that a section, word, or phrase is confusing/challenging). The user may also provide feedback to the personalized reading assistance program 134 during and/or after the new reading performance evaluation, which may be evaluated by machine learning. The user feedback may be written, spoken, or obtained by user answers to a generated survey. The personalized reading assistance program 134 may determine times/text positions (e.g., words, phrases, sentences, paragraphs, sections, pages, etc.) corresponding to the user's reflexive reactions, purposeful reactions, and/or feedback compared with the reading pacer's position and/or the user's eye movement/position. Even in the absence of a user reflexive reaction and/or a purposeful response, a calculated eye position and/or reading pace of the user that diverges from an average reading pace (e.g., determined by calculated eye position on a page relative to predicted position and/or eye position lagging the reading pacer) may trigger the personalized reading assistance program 134 to learn associated patterns (e.g., struggle patterns, ease patterns, etc.). For example, the associated struggle patterns may include the responsible words, conditions (e.g., time elapsed since reading began) and/or text segment features (e.g., sentence/paragraph/page length, characters, awkward grammar, redundancy, etc.) determined to accompany a slowing of the user's reading pace. Word(s) that precede a slowing of the user's reading pace may be referred to as complex words. In an embodiment, the reading assistance program 134 may calculate a gradual slowing of the user's reading pace over a predetermined length of time and determine that X number of characters and/or words in a same sentence, paragraph, section, and/or text corpus hinders the user's reading pace. This cumulative slowing effect might not necessarily be caused by words that are independently deemed complex words or it may result in a greater decrease in the user's reading pace than predicted by the quantity of complex words in the text segment. The personalized reading assistance program 134 may also use semantic analysis to determine a subject that slows a user's reading pace.

The personalized reading assistance program 134 may analyze the user's reading performance evaluations and background inputs using machine learning and determine a reading ability score for the user. The personalized reading assistance program 134 may identify deficiencies, suggestions, potential diagnoses (e.g., reading disabilities, anatomical or neurological abnormalities, etc.), and/or patterns (e.g., textual, activity based, etc.) that relate to changes in the user's reading pace. The user's reading ability score may vary by subject and/or text corpus complexity level. In an embodiment of the present inventive concept, the personalized reading assistance program 134 may generate a personalized user dictionary with a complexity matrix (e.g., for each reading performance evaluation, text corpus, subject, and/or user). The user dictionary with the complexity matrix may include a plurality of complex words identified for the user and a plurality of complexity factors. The complexity factors may include the calculated need for alteration (e.g., substitution, abbreviation, acronymization, etc.), difficulty level (e.g., determined by number and degree of complexity factors and/or magnitude of resultant user reading pace slowing), need for chunking, need for personalized images, and/or inclusion of a suffix and/or prefix. However, because fatigue and distraction may skew the user's reading performance evaluation and thus may cause erroneous identification of complex words, the user may review the identified complex words and/or problematic patterns and confirm or deny the subjective veracity accordingly. The user may make direct edits (additions, deletions, etc.) to the user dictionary with the complexity matrix. The personalized reading assistance program 134 may learn from the user's reading performance evaluations and manual edits to their user dictionaries with the complexity matrices. The resultant models, user dictionaries with the complexity matrices, and corresponding data (e.g., reading performance evaluations, eye movement/position recordings, background inputs, edits, etc.) may be stored in the personalized reading assistance repository 132.

For example, the personalized reading assistance program 134 may conduct the reading ability evaluation for a user using a chapter from a text corpus related to physics. The user has a high subject familiarity with physics despite the text complexity, but reportedly struggles with reading pace nonetheless based on a manual background input. During the user's reading performance evaluation, the personalized reading assistance program 134 consistently detects atypical eye movement. The pattern of atypical eye movement the user exhibits while reading is known to occur in individuals with dyslexia. The personalized reading assistance program 134 may suggest or corroborate a diagnosis of dyslexia. In addition, the words “equipartition”, “centrifugal”, “centripetal” are associated with a slowing of the user's reading pace. The user often confuses centrifugal and centripetal and deliberates on this distinction briefly when reading. These identified complex words are thus added to the user's dictionary with the complexity matrix with respective complexity scores of 3/5, 2/5, 2/5 respectively. The complex words can be chunked, represented pictorially, and/or the prefixes equi/centri/centri can be highlighted. The personalized reading assistance program 134 also detects that the user appears to become fatigued and/or overwhelmed when consecutive sentences contain more than 35 words and consecutive paragraphs contain more than 20 sentences and would benefit from periodic skimming, suggested breaks, etc. The user's overall reading ability score is determined to be 75/100 for physics and 85/100 in general.

The personalized reading assistance program 134 may forecast the text corpus complexity for the user (step 204). The personalized reading assistance program 134 may analyze a selected text corpus (e.g., user selected, next in a queue, sequence, subject progression, syllabus, etc.) using NLP. The selected text corpus' composition (e.g., inclusion of the complex words from the user dictionary with the complexity matrix, length, character quantity, subject, grammar, etc.) may influence the forecast text corpus complexity. The forecast text corpus complexity may include a recommended reading ability score. The recommended reading ability score may be compared with the user's determined reading ability. The personalized reading assistance program 134 may forecast the user's reading performance (e.g., pace, comprehension, etc.) based on the difference between the recommended reading ability and the user's reading ability. When complex words from the user's dictionary with the complexity matrix and/or struggle patterns are detected, the impact on the user's average or subject specific reading pace will be calculated by the personalized reading assistance program 134. In an embodiment, a deficit between the user's reading ability score and the recommended reading ability score may trigger a need for greater use of visual modifications in a subsequent step or recommendation of another text corpus (e.g., an analyzed text corpus from the personalized reading assistance repository 132 that more closely approximates the user's reading ability). The contribution of each complexity factor from the user dictionary with the complexity matrix may be scored and/or notated for the user's review. The personalized reading assistance program 134 may predict the viability and impact of potential visual modifications to the user's forecast reading performance enhancement and provide a forecast assisted reading performance. If visual modifications exceed a predetermined quantity per sentence, paragraph, page, etc., the personalized reading assistance program 134 may prioritize complex words with higher difficulty scores to avoid excessive crowding and a further decreased user reading ability.

For example, the personalized reading assistance program 134 may analyze another chapter of the physics text corpus in advance of the user reading it. The personalized reading assistance program 134 may detect repetitious use of the identified complex words “equipartition”, “centrifugal”, and “centripetal”, sentences that contain more than 35 words and multiple consecutive paragraphs that contain more than 20 sentences. The forecast text corpus complexity is based on a recommended reading ability score of 85/100 whereas the user's reading ability in physics was determined to be 75/100. A large quantity of pictural representations is indicated as well as highlighting the prefix/suffixes. The complex words are also determined to be separated by sufficient space (predetermined) such that visual modifications will not cause clutter and detract from reading pace via distraction.

The personalized reading assistance program 134 may provide the visual modifications to the text corpus (step 206). The visual modifications may be personalized to the user based on their associated user dictionary and the complexity matrix, identified patterns, background inputs, and/or the reading performance evaluation results. Complex words may be substituted with lower difficulty synonyms and/or at least partially greyed out. Prefixes, suffixes, and chunked words, etc. may be highlighted with color (e.g., different colors) for each component as selected by the user or a determined optimal color from the user's reading performance evaluations. Certain handicaps may be mitigated using the visual modifications (e.g., words reversed for dyslexic users, font enlarged or substituted for the sight impaired, etc.). The personalized reading assistance program 134 may crop and/or highlight words (e.g., the bottom or top vertical portions of words) in the text corpus (not necessarily only complex words and/or struggle patterns), and thus the user can read the text corpus more quickly. Similarly, letters and/or words may be removed to facilitate a faster reading pace. Pictural representations for complex words may be depicted as emojis, animations, video clips, symbols, and/or literal images, etc. The pictural representations may appear automatically immediately prior to or during a personalized pacer and/or user eye position overlapping an associated word, or there may be an indication to the user that a hidden pictural representation can be revealed (e.g., box, highlight, asterisk, etc.) with a predetermined user gesture or action (e.g., hovering, clicking, verbal cue, etc.). Preferred pictural representation type/frequency may be selected by the user and/or chosen by the personalized reading assistance program 134 automatically based on the prior reading performance evaluation and feedback to visual modifications. Pictural representations may be retrieved by the personalized reading assistance program 134 from the personalized reading assistance repository 132 where available, a relevant image from a same or different analyzed text corpus (e.g., the relevance of which may be determined by OCR or NLP of explanatory text), and/or from a search of the interne for the term (e.g., image search and model application to confirm accuracy).

In an embodiment, various approaches to partitioning complex words exist:

Method for complex word partitioning:
1. Chunking word into (prefix, root word, suffix).
2. Syllable division provides an effective strategy in for chunking up bigger words into more manageable parts. It also helps people to determine what the vowel sound will be. The method is as follows:
   a. Find the vowels in the word.
   b. Find the patten of the consonants and vowels (VCV, VCCV, VCCCV, VCCCCV, C+le, VV).
   c. Use the syllable division rule to divide the word into its syllable parts.
      i. VCCV: divide between two middle consonants.
      ii. VCV: divide after the consonant when the 1st vowel has a short sound or divide before the consonant when the 1st vowel has a long sound.
      iii. C+LE: divide before the consonant LE.
      iv. VCCCV: with 3 consonants between the vowel, split after 1st consonant.
      v. VCCCCV: with 4 consonants between the vowel, split after 1st consonant.
3. Word containment: if a smaller word exists in a complex word, divide them.

NLP libraries such as NLTK and SpaCy which provide information on prefix, suffix, rood word, vowels, consonants, lookup dictionary, etc. may be used.

The visual modifications may be performed on singular or plural words, text segments (e.g., sentences, paragraphs, etc.), prefixes, suffixes, otherwise split words, and/or entire text segments exhibiting an identified pattern. The visual modifications may be populated in advance of a reader beginning to read a text corpus; upon user prompt; synchronized with the movement of a personalized reading pacer and/or user eye movement/position; and/or at a predetermined pace (e.g., the user reading pace). In an embodiment, only complex words with a predetermined difficulty score or greater (e.g., determined by the user or the personalized reading assistance program 134) will receive the visual modifications. The visual modifications may be provided onto a digital text corpus or a physical text corpus (e.g., using OCR enabled smart glasses/contact lenses to scan an image and/or virtually depict the visual modifications in conjunction with the personalized pacer). With respect to the digital text corpus, the personalized reading assistance program 134 may import, download, scan, and/or otherwise copy text thereof into an editable format if direct inclusion/projection of the visual modifications is frustrated.

In an embodiment, the personalized pacer may have several reading modes depending on at least one reading goal selected by the user (e.g., scanning, skimming, comprehension improvement, reading pace improvement, etc.). The personalized reading pacer scanning mode may highlight high yield words and text segments (e.g., based on prior semantic analysis) in the text corpus. For example, the personalized reading pacer in scanning mode may highlight only the first and last sentences of paragraphs which are reliably high yield based on empirical evidence. The personalized reading pacer skimming mode may highlight words at random or in periodic intervals. The scanning mode and skimming mode may ignore complex words, struggle patterns, stop words, etc.

For example, the personalized reading assistance program 134 activates scanning mode for the sentences in the physics chapter that contain more than 35 words and the consecutive paragraphs that contain more than 20 sentences. The surrounding text which is not highlighted by the personalized pacer in these text segments is greyed out. Complex words are reversed to accommodate the user's dyslexia, and the words “equipartition”, “centrifugal”, and “centripetal” have the prefixes highlighted with green, which is determined to be an optimal prefix color for the user based on their reading performance evaluations and background input (user is blue-yellow color blind). In addition, a circle with an inward pointing arrow may be used to depict centripetal, whereas a circle with an outward pointing arrow may be used to depict centrifugal. The user may nod while their eye position and/or personalized pacer is located on the complex words to endorse the subjective benefit of the provided visual modifications.

The personalized reading assistance program 134 may evaluate the user's assisted reading ability and adjust accordingly (step 208). The personalized reading assistance program 134 may evaluate the user's assisted reading ability (or solely the user's assisted reading performance evaluation) in a similar manner to that which is described with respect to step 202. In the case of a comprehensive assisted reading ability assessment, recent background inputs such as lack of sleep may be preemptively accounted for by using a predetermined handicap to the user's forecast reading pace and/or comprehension. The personalized reading assistance program 134 may be equipped to make dynamic visual modification and/or personalized pacer pace/format changes while the user is actively engaged in reading a text corpus based on a predetermined user response (e.g., verbal, physical, or written) and/or based on reading performance analysis. For example, the user may indicate to the personalized reading assistance program 134 that a subjective complex word without visual modification (e.g., low difficulty score or not included in the user dictionary with the complexity matrix) requires one to be provided by shaking their head from side to side. The user dictionary with the complexity matrix may be updated with new complex words and/or updated complexity factors as indicated by the user and/or identified by the personalized reading assistance program 134 on a dynamic basis. The personalized reading assistance program 134 may also remove complex words from the user dictionary with the complexity matrix that no longer slow the user's reading pace.

The visual modifications may be increased until a point of diminishing returns to a user reading goal (e.g., reading pace) is reached, or reverted to an earlier quantity/type if the user's assisted reading performance deteriorates. Each type of visual modification may have a different impact on the user's assisted reading performance, and thus each type may be adjusted in proportion to the benefit or detriment to the user's assisted reading performance as determined by the personalized reading assistance program 134 and/or user feedback/responses. The personalized reading pacer may be adjusted over time to become progressively more personalized by tracking the user's reading performance evaluation continually. The personalized reading pacer may be configured by the personalized reading assistance program 134 and/or the user to provide incremental, predetermined reading pacer adjustments to pace and/or visual modifications (within a same text corpus or between different text corpara) for at least one user reading goal. The personalized reading pacer optimal pace alterations may be based on the user's most recently assessed and/or in-progress assisted reading ability assessment. The personalized reading assistance program 134 may learn from the assisted reading performance evaluations and tune associated models accordingly. In an embodiment, the preliminary-personalized pacer may be based on prevailing configurations of personalized pacers from users with at least one similar background input and/or reading performance evaluation.

For example, the personalized reading assistance program 134 may dynamically analyze the user's assisted reading performance as the user reads the physics chapter for which visual modifications have been scheduled. The words “equipartition”, “centrifugal”, and “centripetal” are no longer slowing the user's reading pace even after the personalized reading assistance program 134 reduces the frequency of visual modifications therefor. Thus, these formerly complex words are removed from the user dictionary with the complexity matrix. However, the user has manually highlighted the word “Babinet's principle” and double left clicked the word to indicate speed impediment and double right clicked the word to indicate a lack of comprehension. Babinet's principle states that the diffraction pattern from an opaque body is identical to that from a hole of the same size and shape except for the overall forward beam intensity. Thus, the personalized reading assistance program 134 updates the user dictionary with the complexity matrix accordingly and generates an image depicting Babinet's principle. The initial visual modification image is unclear to the user, so the user presses the space bar to generate another image and the personalized reading assistance program 134 learns from this user action and will learn features of accepted visual modifications. In subsequent text corpora for physics, the personalized reading pacer speed may be increased by a predetermined amount until a fall-off point is reached as indicated by diminished reading performance evaluation that exceeds a tolerable amount (some decrease is permitted given the enhanced speed and compromise).

As described, the embodiments of the present inventive concept provided herein enable the user to enjoy personalized and evolving reading pace assistance. With particular reference to the embodiments that include the use of smart glasses or contact lenses, the contexts of the present inventive concept's use are innumerous; they include school (e.g., blackboard, textbooks, etc.), billboards, sporting events, user software agreements, movies, and many more.

FIG. 3 illustrates a block diagram depicting the hardware components of the personalized reading assistance system 100 of FIG. 1, in accordance with an exemplary embodiment of the present inventive concept.

It should be appreciated that FIG. 3 provides only an illustration of one implementation and does not imply any limitations regarding the environments in which different embodiments may be implemented. Many modifications to the depicted environment may be made.

Devices used herein may include one or more processors 302, one or more computer-readable RAMs 304, one or more computer-readable ROMs 306, one or more computer readable storage media 308, device drivers 312, read/write drive or interface 314, network adapter or interface 316, all interconnected over a communications fabric 318. Communications fabric 318 may be implemented with any architecture designed for passing data and/or control information between processors (such as microprocessors, communications and network processors, etc.), system memory, peripheral devices, and any other hardware components within a system.

One or more operating systems 310, and one or more application programs 311 are stored on one or more of the computer readable storage media 308 for execution by one or more of the processors 302 via one or more of the respective RAMs 304 (which typically include cache memory). In the illustrated embodiment, each of the computer readable storage media 308 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 314 to read from and write to one or more portable computer readable storage media 326. Application programs 311 on said devices may be stored on one or more of the portable computer readable storage media 326, read via the respective R/W drive or interface 314 and loaded into the respective computer readable storage media 308.

Devices used herein may also include a network adapter or interface 316, such as a TCP/IP adapter card or wireless communication adapter (such as a 4G wireless communication adapter using OFDMA technology). Application programs 311 on said computing devices may be downloaded to the computing device from an external computer or external storage device via a network (for example, the Internet, a local area network or other wide area network or wireless network) and network adapter or interface 316. From the network adapter or interface 316, the programs may be loaded onto computer readable storage media 308. The network may comprise copper wires, optical fibers, wireless transmission, routers, firewalls, switches, gateway computers and/or edge servers.

Devices used herein may also include a display screen 320, a keyboard or keypad 322, and a computer mouse or touchpad 324. Device drivers 312 interface to display screen 320 for imaging, to keyboard or keypad 322, to computer mouse or touchpad 324, and/or to display screen 320 for pressure sensing of alphanumeric character entry and user selections. The device drivers 312, R/W drive or interface 314 and network adapter or interface 316 may comprise hardware and software (stored on computer readable storage media 308 and/or ROM 306).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

It is to be understood that although this disclosure includes a detailed description on cloud computing, implementation of the teachings recited herein are not limited to a cloud computing environment. Rather, the exemplary embodiments of the present inventive concept are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 4 illustrates a cloud computing environment, in accordance with an exemplary embodiment of the present inventive concept.

As shown, cloud computing environment 50 may include one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 40 and cloud computing environment 50 can communicate with any type of computerized device over any type of network and/or network addressable connection (e.g., using a web browser).

FIG. 5 illustrates abstraction model layers, in accordance with an exemplary embodiment of the present inventive concept.

Referring now to FIG. 5, a set of functional abstraction layers provided by cloud computing environment 50 (FIG. 4) is shown. It should be understood in advance that the components, layers, and functions shown in FIG. 5 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfilment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and personalized reading assistance 96.

The exemplary embodiments of the present inventive concept may be a system, a method, and/or a computer program product at any possible technical detail level of integration. The computer program product may include a computer readable storage medium (or media) having computer readable program instructions thereon for causing a processor to carry out aspects of the present inventive concept.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present inventive concept may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present inventive concept.

Aspects of the present inventive concept are described herein with reference to flowchart illustrations and/or block diagrams of methods, apparatus (systems), and computer program products according to exemplary embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present inventive concept. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications, additions, and substitutions can be made without deviating from the scope of the exemplary embodiments of the present inventive concept. Therefore, the exemplary embodiments of the present inventive concept have been disclosed by way of example and not by limitation.

1. A method for providing personalized reading assistance using visual modifications, the method comprising:
forecasting a complexity of a text corpus for a user, wherein the text corpus includes a plurality of words; and
providing visual modifications to at least some words of the plurality of words in the text corpus based on the forecast complexity of the text corpus for the user.

2. The method of claim 1, further comprising:
determining a user reading ability of the user, wherein the determined user reading ability is based on at least one of user reading speed, user reading reactions, and user background inputs; and
identifying a plurality of complex words from among the plurality of words in the text corpus based on the determined reading ability of the user.

3. The method of claim 2, further comprising:
generating a user dictionary of the identified complex words; and
generating a complexity matrix for each of the identified complex words, wherein the complexity matrix includes at least one of difficulty level, need for chunking, need for personalized images, and a suffix or prefix,
wherein the provided visual modifications for the identified complex words are based on the complexity matrix.

4. The method of claim 3, further comprising:
evaluating a user reading performance of the text corpus; and
adjusting the visual modifications to achieve at least one user reading goal, wherein the user reading goal includes at least one of increasing user reading speed, increasing user reading comprehension, mitigating a learning disability, and decreasing eye or mental fatigue.

5. The method of claim 4, further comprising:
highlighting only a portion of the at least some words or vertically cropping the at least some words.

6. The method of claim 1, wherein the provided visual modifications include a reading pacer and a scanning mode which demarcates essential words that carry the gist of the text corpus as determined by machine learning.

7. The method of claim 1, wherein the provided visual modifications include a reading pacer and a skimming mode which demarcates words in the text corpus at periodic intervals and/or at a different pace relative to a predetermined user reading pace.

8. The method of claim 1, wherein the text corpus is a hard copy document, and
wherein the visual modifications are provided using smart glasses or lenses via optical character recognition (OCR) techniques.

9. A computer program product for providing personalized reading assistance using visual modifications, the computer program product comprising:
one or more non-transitory computer-readable storage media and program instructions stored on the one or more non-transitory computer-readable storage media capable of performing a method, the method comprising:
forecasting a complexity of a text corpus for a user, wherein the text corpus includes a plurality of words; and
providing visual modifications to at least some words of the plurality of words in the text corpus based on the forecast complexity of the text corpus for the user.

10. The method of claim 9, further comprising:
determining a user reading ability of the user, wherein the determined user reading ability is based on at least one of user reading speed, user reading reactions, and user background inputs; and
identifying a plurality of complex words from among the plurality of words in the text corpus based on the determined reading ability of the user.

11. The method of claim 12, further comprising:
generating a user dictionary of the identified complex words; and
generating a complexity matrix for each of the identified complex words, wherein the complexity matrix includes at least one of difficulty level, need for chunking, need for personalized images, and a suffix or prefix,
wherein the provided visual modifications for the identified complex words are based on the complexity matrix.

12. The method of claim 11, further comprising:
evaluating a user reading performance of the text corpus; and
adjusting the visual modifications to achieve at least one user reading goal, wherein the user reading goal includes at least one of increasing user reading speed, increasing user reading comprehension, mitigating a learning disability, and decreasing eye or mental fatigue.

13. The method of claim 12, further comprising:
highlighting only a portion of the at least some words or vertically cropping the at least some words.

14. The method of claim 9, wherein the provided visual modifications include a reading pacer and a scanning mode which demarcates essential words that carry the gist of the text corpus as determined by machine learning.

15. A computer system for providing personalized reading assistance using visual modifications, the system comprising:
one or more computer processors, one or more computer-readable storage media, and program instructions stored on the one or more of the computer-readable storage media for execution by at least one of the one or more processors capable of performing a method, the method comprising:
forecasting a complexity of a text corpus for a user, wherein the text corpus includes a plurality of words; and
providing visual modifications to at least some words of the plurality of words in the text corpus based on the forecast complexity of the text corpus for the user.

16. The method of claim 15, further comprising:
determining a user reading ability of the user, wherein the determined user reading ability is based on at least one of user reading speed, user reading reactions, and user background inputs; and
identifying a plurality of complex words from among the plurality of words in the text corpus based on the determined reading ability of the user.

17. The method of claim 16, further comprising:
generating a user dictionary of the identified complex words; and
generating a complexity matrix for each of the identified complex words, wherein the complexity matrix includes at least one of difficulty level, need for chunking, need for personalized images, and a suffix or prefix,
wherein the provided visual modifications for the identified complex words are based on the complexity matrix.

18. The method of claim 17, further comprising:
evaluating a user reading performance of the text corpus; and
adjusting the visual modifications to achieve at least one user reading goal, wherein the user reading goal includes at least one of increasing user reading speed, increasing user reading comprehension, mitigating a learning disability, and decreasing eye or mental fatigue.

19. The method of claim 18, further comprising:
highlighting only a portion of the at least some words or vertically cropping the at least some words.

20. The method of claim 15, wherein the provided visual modifications include a reading pacer and a scanning mode which demarcates essential words that carry the gist of the text corpus as determined by machine learning.
